(19) United States
(12) Patent Application Publication
(10) Pub. No.: US 2017/0247568 A1
(43) Pub. Date: Aug. 31, 2017

(54) Multi-Layer Coating System, Coating Method, and Coated Substrate Therewith

(71) Applicant: PPG Coatings (Tianjin) Co., Ltd., Tianjin (CN)

(72) Inventors: Yuanjie Song, Tianjin (CN); Zhengsong Luo, Tianjin (CN); Zhixin Yin, Tianjin (CN)

(21) Appl. No.: 15/328,098

(22) PCT Filed: Jul. 22, 2015
(86) PCT No.: PCT/CN2015/084778

§ 371 Date: Jan. 23, 2017

(30) Foreign Application Priority Data
Jul. 23, 2014 (CN) 201410353120.X

(51) Int. Cl. C09D 175/16; C09D 167/07; B05D 7/00; C09D 133/00

(52) U.S. Cl. CPC C09D 175/16; C09D 133/00; C09D 167/07; B05D 7/53

(57) ABSTRACT

The present invention provides a multi-layer coating system, comprising a first coating composition and a second coating composition, wherein the first coating composition comprises an acrylic resin (a) having a glass transformation temperature (Tg) of at least 70° C. and the second coating composition comprises a three-functionality polyester acrylate, a six-functionality polyurethane acrylate, and a nine-functionality polyurethane acrylate. The present invention further provides a method of coating a multi-layer coating system on a substrate and a substrate coated with the multi-layer coating system.

### FIELD OF INVENTION

The present invention relates to a high gloss multi-layer coating system, in particular to a multi-layer coating system comprising a first coating composition comprising an acrylic resin having a glass transformation temperature and a second coating composition comprising a combination of resins having three different functionalities. The present invention also relates to a method of coating a substrate with the multi-layer coating system and the substrate coated with the multi-layer coating system.

### BACKGROUND

Ultraviolet (UV) curing is an advanced technique for treating the surface of a material, which initiates a liquid material having chemical activity to quick crosslink and polymerize, and then immediately cure and form a film by using an ultraviolet ray. The UV curing technology has advantages characterized by “5E”, including high efficiency, economy, energy-saving, environmental-friendly, and enabling, and it has become a green industry new technique. It has been widely used in quick curing of coatings, inks, crosslinkers, structure materials, especially suitable for the surface coating of electronics consumer products.

Currently, the shell of electronics products, particularly mobile phones is usually coated with a system of a basecoat and a UV topcoat. The basecoat uses a 1K coating system with an extended life span. The resulting coating film will basically require no baking after forming film with one baking, thereby saving energy. The UV topcoat has advantages of quick curing, saving energy, high production efficiency, good curing performance, and being suitable for high-speed automatic production. However, the existing dual-coating systems, after being subjected to hot water bath, temperature cycle, QUV testing, are difficult to overcome the problematic film blistering, which affects the texture and appearance of the mobile phones. Therefore, there is a need for a multi-layer coating system which can overcome the blistering for the system of basecoat plus UV topcoat and have a high gloss.

### SUMMARY OF THE INVENTION

The present invention provides a multi-layer coating system, comprising a first coating composition and a second coating composition, wherein the first coating composition comprises an acrylic resin (a) having a glass transformation temperature (Tg) of at least 70° C., and the second coating composition comprises a three-functionality polyester acrylate, a six-functionality polyurethane acrylate, and a nine-functionality polyurethane acrylate.

The present invention further provides a method of forming the multi-layer coating system on a substrate, comprising: (1) applying the first coating composition to at least a portion of the substrate, to form a base coat; and (2) applying the second coating composition to at least a portion of the base coat, to form a clear coat.

The present invention further provides a coated substrate, comprising a substrate, and the multi-layer coating system deposited on at least a portion of the substrate.

### DETAILED DESCRIPTION

Other than in the operating examples, or where otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

In one embodiment, a multi-layer coating system is provided, comprising a first coating composition and a second coating composition, wherein the first coating composition comprises an acrylic resin (a) having a glass transformation temperature (Tg) of at least 70° C., and the second coating composition comprises a three-functionality polyester acrylate, a six-functionality polyurethane acrylate, and a nine-functionality polyurethane acrylate.

The first coating composition is usually coated on at least a portion of a substrate as a base coat.

In the first coating composition, the acrylic resin (a) preferably has a glass transformation temperature ranging from about 75-90° C. Said acrylic resin typically has a weight average molecular weight ranging from 10,000 to 150,000, preferably ranging from 30,000 to 120,000, and more preferably ranging from 30,000-80,000. Suitable acrylic resins can be a homopolymer or a copolymer, which may be polymerized by one or more monomers selected from acrylic acid, methylacrylic acid, methyl acrylate, ethyl acrylate, butyl acrylate, iso-butyl acrylate, β-hydroxyl ethyl acrylate, iso-octyl acrylate, isobornyl acrylate, lauryl acrylate, hydroxy butyl acrylate, 2-hydroxy propyl acrylate, stearyl acrylate, methyl methacrylate, ethyl methacrylat, butyl methacrylate, isobutyl methacrylate, β-hydroxyl ethyl methacrylate, styrene, iso-octyl methacrylate, isobornyl methacrylate, lauryl methacrylate, 2-hydroxy propyl methacrylate, and stearyl methacrylate.

Typically, the acrylic resin (a) is present in the first coating composition in an amount of 10-50% by weight of the first coating composition. When the amount of the acrylic resin is less than 10 wt %, the coating film formed from the first coating composition is soft, with good adherence. However, after the second coating is coated, the resulting coating film has good adherence, but with severe blistering upon hot water bath testing. When the amount thereof is higher than 50 wt %, the resulting coating film has improved hot-water boiling resistance, with poor adherence. A balance of excellent adherence and hot-water boiling resistance will be achieved when the amount of the acrylic resin is in the range described above.

Many of such acrylic resins which are commercially available can be used in the present invention. For example, examples of such acrylic resins that can be used in the present invention include, but are not limited to, DSM from NEOCRYL B-805, DIANAL MB-2952 and LR-7666 from Mitsubishi Rayon Co. Ltd., ACRYDIC SHA-288A from DIC, A-33R from Jiahe Taiwan, and any combination thereof.

The first coating composition may further comprise an acrylic resin (b) having a glass transformation temperature ranging from 30-65° C.

The acrylic resin (a) preferably has a glass transformation temperature ranging from about 50-65° C. Said acrylic resin typically has a weight average molecular weight ranging from 10,000 to 150,000, preferably ranging from 30,000 to 120,000, and more preferably ranging from 30,000-80,000. Suitable acrylic resins can be a homopolymer or a copolymer, which may be polymerized by one or more monomers selected from acrylic acid, methylacrylic acid, methyl acrylate, ethyl acrylate, butyl acrylate, iso-butyl acrylate, β-hydroxyl ethyl acrylate, iso-octyl acrylate, isobornyl acrylate, lauryl acrylate, hydroxy butyl acrylate, 2-hydroxy propyl acrylate, stearyl acrylate, methyl methacrylate, ethyl methacrylat, butyl methacrylate, isobutyl methacrylate, β-hydroxyl ethyl methacrylate, styrene, iso-octyl methacrylate, isobornyl methacrylate, lauryl methacrylate, 2-hydroxy propyl methacrylate, and stearyl methacrylate.

The acrylic resin (b) can be present in the first coating composition in an amount of 5-25% by weight of the first coating composition. When the amount of the acrylic resin is less than 5 wt %, the coating film has deteriorated adherence. When the amount thereof is higher than 25 wt %, the resulting coating film has improved adherence, but with severe blistering upon hot water bath testing.

Many of such acrylic resins which are commercially available can be used in the present invention. For example, examples of such acrylic resins that can be used in the present invention include, but are not limited to, PARALOID B44 from Rohmhaas, AD70 from Hitachi-chem, SHA-288 from DIC, and any combination thereof.

In one preferred embodiment, said first coating composition may comprise about 10-50 wt % of the acrylic resin (a) and about 5-25 wt % of the acrylic resin (b) based on the weight of the first coating composition.

The first coating composition of the multi-layer coating composition according to the present invention may further comprise an organic solvent and one or more other additives commonly used in the field to which the present invention belongs.

There is no specific limitation to the solvent used, which can be any of organic solvents known by those skilled in the art and which includes, without limitation, an aliphatic or aromatic hydrocarbon such as Solvesso 100™, toluene or xylene, an alcohol such as butanol or isopropanol, an ester such as ethyl acetate, butyl acetate, or iso-butyl acetate, a ketone such as acetone, methyl isobutyl ketone or methyl ethyl ketone, an ether, an ether-alcohol or an ether ester such as ethyl 3-ethoxypropionate or a mixture of any of these. Preferably it is ethyl acetate and/or methyl ethyl ketone. The solvent is usually in an amount of 0-50 wt % of the first coating composition.

Said one or more other additives include, but are not limited to a dispersant, a leveling agent, an antioxidant, a deforming agent, a rheological agent, and the like. The types of these additives are well-known by those skilled in the art and the amount thereof will be easily determined by those skilled in the art as needed.

In certain embodiments, the first coating composition comprises a cellulose ester additive, such as cellulose acetate (CA), cellulose acetate propionate (CAP), and/or cellulose acetate butyrate (CAB). Such additives can improve the appearance of the color-plus-clear coating system by improving the flow and leveling of the first coating composition and improving metal flake orientation if such flakes are present in the to provide a “metallic” look, as is sometimes desirable. Moreover, such additives can improve the appearance of the first coating composition by promoting fast drying and early hardness development of the first coating composition, thereby helping to reduce intermixing of the subsequently applied second coating composition (UV curable composition). Additionally, the cellulose ester additives can be present in any amount sufficient to impart the desired coating properties. For example, such cellulose ester may comprise from 0.5 to 10 wt % of the first coating composition.

The second coating composition is a UV curable coating composition, which is coated onto the first coating composition as a clear coat.

In the second coating composition described in the present invention, the three-functionality polyester acrylate is a reaction product of hydroxyl polyester and acrylic acid. Preferably, suitable three-functionality polyester acrylate usually has a viscosity of about 5000-12000 mPa at ambient temperature and a glass transformation temperature higher than about 250° C. Among low-functionality UV curable oligomers, said three-functionality polyester acrylate possess excellent flexibility and water repellence.

Typically, the three-functionality polyester acrylate is present in the second coating composition in an amount of about 5-25% by weight of the second coating composition. When the amount of the three-functionality polyester acrylate is less than 5 wt %, the resulting coating film has improved hot-water boiling resistance, but with poor adherence, resulting in a fragile film. When the amount thereof is higher than 25 wt %, the resulting coating film has poor hot-water boiling resistance and severe blistering.

Many three-functionality polyester acrylates which are commercially available can be used in the present invention. For example, examples of the three-functionality polyester acrylates that can be used in the present invention include, but are not limited to, 6130B-80, EM2382, and 6151 from CHANGXING; CN989 from Arkema; EB8405 from Allnex; M-7100 from East Asia Compound Chemical Company Ltd.; M-8060 from TOA-DIC ZHANGJIAGANG CHEMICAL; and any combination thereof.

In the second coating composition described in the present invention, said six-functionality polyurethane acrylate is a condensation product from pentaerythritol triacrylate, aliphatic diisocyanate, and hydroxyl polyol. Preferably, the six-functionality polyurethane acrylate has a structural formula of PETA-diisocyanate-backbone-diisocyanate-PETA. Said six-functionality polyurethane acrylate has advantages of good abrasion resistance, high surface hardness, and quick curing. It also has excellent adherence, flexibility, leveling, and water proof properties, but with the defect of yellowing and lifting.

Typically, the six-functionality polyurethane acrylate is present in the second coating composition in an amount of about 5-25% by weight of the second coating composition. When the amount of the six-functionality polyurethane acrylate is less than 5 wt %, the resulting coating film has poor adherence, resulting in a fragile film. When the amount thereof is higher than 25 wt %, the resulting coating film has improved adherence, but is susceptible to lifting, thereby affecting the appearance of the coating. Furthermore, yellowing of the coating is increased.

Many six-functionality polyurethane acrylates which are commercially available can be used in the present invention. For example, examples of the six-functionality polyurethane acrylates that can be used in the present invention include, but are not limited to, U-0606 from Lida, DR-U123 from Changxing, GU6300Y from QUALIPOLY CHEMICAL CORP, and any combination thereof.

In the second coating composition described in the present invention, said nine-functionality polyurethane acrylate is a reaction product of polyisocyanate and hydroxyl-acrylate. Among high-functionality UV curable oligomers, said nine-functionality polyurethane acrylate possess excellent flexibility. Moreover, said resin has superior chemical resistance and water repellence.

Typically, the nine-functionality polyurethane acrylate is present in the second coating composition in an amount of about 5-50% by weight of the second coating composition. When the amount of the nine-functionality polyurethane acrylate is less than 5 wt %, the resulting coating film has improved flexibility, but with poor hot-water boiling resistance. When the amount thereof is higher than 50 wt %, the resulting coating film has improved hot-water boiling resistance, while the coating becomes fragile and has deteriorated adherence.

Many nine-functionality polyurethane acrylates which are commercially available can be used in the present invention. For example, examples of the nine-functionality polyurethane acrylates that can be used in the present invention include, but are not limited to, RA1353, RA4800M from MITSU; UN-3320HS from Negami; DR-U076, 6195-100, and 6197 from CHANGXING; SC2152 from Miwon; U-0930 from Leader Formula; EB1290N from Allnex; CN9010 from Arkema; W4905 from GUANGZHOU WUX MATERIAL CO, and any combination thereof.

In one embodiment, the second coating composition in the multi-layer coating system of the present invention further comprises 5-25 wt % of a dilute monomer based on the weight of the second coating composition. The dilute monomer used is preferably a dual-function acrylate monomer. When the amount of the dilute monomer present in the second coating composition is too low, the composition has a high viscosity, resulting in deteriorated operability and poor leveling. When the amount of the dilute monomer present in the second coating composition is too high, coating lifting easily occurs and affects the appearance of the coating.

The dilute monomers that can be used in the present invention include, but are not limited to, dipropyleneglycol diacrylate, tripropylene glycol diacrylate ester, 1,6-hexanediol diacrylate, diethylene glycol dimethacrylate, polyethylene glycol (400) diacrylate (HDDA), polyethylene glycol diacrylate (600), diethylene glycol dimethacrylate, ethoxylated bisphenol dimethacrylate, tricyclodecane dimethylol diacrylate, propoxide (2) neopentyl glycol diacrylate, and any combination thereof.

In one embodiment, the second coating composition of the multi-layer coating system of the present invention further comprises about 1-9 wt % of a photoinitiator based on the weight of the second coating composition. There is no particular limitation to the photoinitiator used, as long as it can decompose to generate free radicals upon exposure to light radiation and initiate a photopolymerization reaction. Available photoinitiators include, but are not limited to benzoin derivative, benzil ketal derivateice, dialkoxy acetophenone, α-hydroxyalkylphenylketone, a-aminealkylphenylketone, acyl phosphine hydride, esterified oxime ketone compounds, aryl peroxide ester compounds, halo methyl aryl ketone, organic sulphur-containing compounds, benzoylformate, and the like. Two or more photoinitiators may be selected as needed.

The second coating composition of the multi-layer coating composition according to the present invention may further comprises an organic solvent and one or more other additives commonly used in the field to which the present invention belongs, in addition to the components described above.

There is no specific limitation to the solvent used, which can be any of organic solvents known by those skilled in the art and which includes, without limitation, an aliphatic or aromatic hydrocarbon such as Solvesso 100™, toluene or xylene, an alcohol such as butanol or isopropanol, an ester such as ethyl acetate, butyl acetate or iso-butyl acetate, a ketone such as acetone, methyl isobutyl ketone or methyl ethyl ketone, an ether, an ether-alcohol or an ether ester such as ethyl 3-ethoxypropionate or a mixture of any of these. Preferably it is iso-butyl acetate and/or methyl ethyl ketone. The solvent is usually in an amount of 0-50 wt % of the second coating composition.

Said one or more other additives include, but are not limited to a dispersant, a leveling agent, an antioxidant, a deforming agent, a rheological agent, and the like. The types of these additives are well-known by those skilled in the art and the amount thereof will be easily determined by those skilled in the art as needed.

In one embodiment, the present invention further provides a method of forming the multi-layer coating system on a substrate, comprising applying the first coating composition to at least a portion of the substrate as a base coat, and applying the second coating composition to at least a portion of the first coating composition as a clear coat.

Typically, the first coating composition is applied onto at least a portion of the substrate by known techniques in the art. For example, the first coating composition may be applied by one or more of a number of methods including spraying, rolling, curtain coating, dipping/immersion, brushing, or flow coating. Preferably, curing is achieved by baking at 60-80° C. for 10-30 min to evaporate the solvent. The film thickness of the base coat is usually in the range of 5 to 20 μm.

Thereafter, the second coating composition can be applied on the base coat by any method described above and cured. Preferably, curing can be achieved by baking at 45-60° C. for about 5-10 min to allow the solvent to evaporate, and UV irradiating at UV energy of 400-1600 mj/cm2 and irradiation intensity of 80-250 mw/cm. The film thickness of the top coat is usually in the range of 15 to 30 μm.

The multi-layer coating system of the present invention may be applied to any substrate. Said substrate may include, but are not limited to ceramics, woods, leathers, stones, glass, alloy, paper, plastics, fiber, cotton textiles, and the like, preferably metallic or plastic substrates. The plastic substrates particularly refers to one for an electronic device, such as a mobile phone, personal digital assistant, smart phone, personal computer. For example, the plastic substrate can be formed from the group consisting of polypropylene (PC), acrylonitrile-butadiene-styrene (ABS), glass fiber (GF), and any combination thereof.

### Examples

The following examples are provided to illustrate the invention, which, however, are not to be considered as limiting the invention to their details. Unless otherwise indicated, all parts and percentages in the following examples, as well as throughout the specification, are by weight.

Preparation of the First Coating Composition

The first coating composition of the inventive multi-layer coating system is prepared using the components and amounts thereof listed in Table 1.

TABLE 1
Formulation of the first coating composition

| | Exam- | Exam- | Exam- | Exam- | Exam- |
|---|---|---|---|---|---|
| | ple 1 | ple 2 | ple 3 | ple 4 | ple 5 |
| | (wt %*) | (wt %) | (wt %) | (wt %) | (wt %) |
| Thermoplastic | 17.5 | 15.15 | 12.5 | 20.5 | 12.15 |
| acrylic resin ¹ | | | | | |
| Thermoplastic | 10 | 10 | 15 | 5 | 20 |
| acrylic resin ² | | | | | |
| Thermoplastic | 15.15 | 17.5 | 15.15 | 17.15 | 10.15 |
| acrylic resin ³ | | | | | |
| Methyl ethyl | 15 | 15 | 15 | 15 | 15 |
| ketone | | | | | |
| Ethyl acetate | 31.5 | 31.5 | 31.5 | 31.5 | 31.5 |
| Leveling agent⁴ | 0.35 | 0.35 | 0.35 | 0.35 | 0.35 |
| cellulose acetate | 10.5 | 10.5 | 10.5 | 10.5 | 10.5 |
| butyrate ⁵ | | | | | |
| Total | 100 | 100 | 100 | 100 | 100 |

*based on total weight of the first coating composition (g);
¹ DSM NEORESINS NEOCRYL B-805, Tg 90° C.;
² PARALOID B44 ACRYLIC RESIN, Tg 40° C.;
³ DIANAL MB-2952, Tg 84° C.;
⁴BYK-323, organosilicon leveling agent available from BYK;
⁵ CAB381-2, available from Eastman.

Preparation of the Second Coating Composition

The second coating composition of the inventive multi-layer coating system is prepared using the components and amounts thereof listed in Table 2.

TABLE 2
Formulation of the second coating composition

| | Exam- | Exam- | Exam- | Exam- | Exam- |
|---|---|---|---|---|---|
| | ple 6 | ple 7 | ple 8 | ple 9 | ple 10 |
| | (wt %*) | (wt %) | (wt %) | (wt %) | (wt %) |
| Three-functionality | 5 | 10 | 15 | 5 | 25 |
| polyester acrylate ¹ | | | | | |
| Monomer² | 10 | 15 | 10 | 5 | 10 |
| Nine-functionality | 25 | 20 | 25 | 40 | 15 |
| polyurethane | | | | | |
| acrylate ³ | | | | | |
| Six-functionality | 15 | 10 | 5 | 5 | 5 |
| polyurethane | | | | | |
| acrylate ⁴ | | | | | |
| Leveling agent ⁵ | 0.4 | 0.4 | 0.4 | 0.4 | 0.4 |
| Photoinitiator⁶ | 2 | 2 | 2 | 2 | 2 |
| solvent⁷ | 42.6 | 42.6 | 42.6 | 42.6 | 42.6 |
| Total | 100 | 100 | 100 | 100 | 100 |

*based on total weight of the second coating composition (g);
¹ M-8060, available from TOA-DIC ZHANGJIAGANG CHEMICAL;
²EB130, available from Allnex;
³ W4905, available from GUANGZHOU WUX MATERIAL SCIENCE CO;
⁴ GU6300Y, available from QUALIPOLY CHEMICAL CORP;
⁵ BYK-3550 and BYK-333 (in a weight ratio of 3:1), available from BYK;
⁶DBC 184 available from Double Bond Chemical, Taiwan and MBF available from Ciba in a weight ration of 1:1;
⁷Methyl ethyl ketone, isobutyl acetate.

Preparation Process of Coats

The first coating compositions shown in Table 1 (Example 1-5, base coat) are diluted with a diluent formulated by mixing ethyl acetate, isopropanol, and ethylene glycol monobutyl ether in an appropriate ratio, such that the coating compositions after dilution have a viscosity of 8-10 s. Then, the diluted coating compositions are coated onto the substrates (PC, PC+ABS, ABS, or PC+GF) via a spraying coating process followed by baking at 60-80° C. for 10-30 min to remove the solvent and form a base coat. The second coating compositions shown in Table 2 (Example 6-10, top coat) are diluted with a diluent formulated by mixing ethyl acetate, isopropanol, and ethylene glycol monobutyl ether in an appropriate ratio, such that the coating compositions after dilution have a viscosity of 7.5-10 s. Then, the diluted coating compositions are each coated onto the base coats via a spraying coating process followed by baking at 45-60° C. for 5-10 min to remove the solvent. The photoinitiator decomposes to generate active free radicals via exposure to UV light radiation (UV energy: 400-1600 mJ/cm², light intensity: 80-250 mw/cm) and initiates a polymerization between the monomer and the resin, forming a film of three-dimensional crosslinked network. Dual-coat Examples 11-15 is thus prepared.

The, the substrates coated with the dual-coat systems 11-15 will be tested for the following properties. Results are shown in Table 3.

1. Adhesion Testing Between Coating Film and Substrate

The sample surface is cut by 6×6 lines with a NT knife (1 mm² gird (lattice), total number of 25; the marking penetrating all the way to the substrate) and the testing surface remains as even as possible (keeping the blade sharp). If the sample is too small to have enough cross-cutting space, a 45° cross-cut grid will be taken. Nichiban tape (No. 405), Scotch tape (No. 610), or other tapes of the same type (18 mm broad, tape viscosity should be greater than or equal to 5.3 N/18 mm broad) is applied over the sample surface and compacted with a rubber to allow the tape sufficiently in contact with the sample surface. The sample stands for 3 min. Tape is removed by pulling it off rapidly back over itself in an angle of 90°. The testing surface is visually examined and assessed with reference to ISO standard.

ISO Standard Rating

0 scale: 5B

Edges of incisions are completely smooth, and no peeling occurs at the edges of lattices.

1 scale: 4B

There is a small piece of peeling at the intersections of incisions, and actual failure is less than or equal to 5%.

2 scale: 3B

There is peeling at the edges or intersections of incisions, with a peeling area from 5% to 15%.

3 scale: 2B

There is partial peeling or a large piece of peeling along the edges of incisions, or part of lattices are wholly peeled off, with a peeling area in a range of 15%-35%.

4 scale: 1B

There is much peeling at the edges of incisions, or part or all of some lattices are peeled off, with a peeling area in a range of 35%-65%.

5 scale: 0B

The painting peels off significantly at the edges or intersections of incisions, with a peeling area greater than 65%.

Typically, when the coating system is used for the shell of a mobile phone, the testing result is required at or above 4B.

2. UV Radiation Testing

Mono cycle: UV radiation for 4 hr (UV-A, 340 nm, 0.63 W/m²/nm, 60° C.), plus humid storage for 4 hr (50° C.), total 12 cycles (4 days). Half of the sample surface is covered with an aluminum foil (for comparing to the surface after being tested).

After UV radiation, changes in color, gloss, and surface roughness of the sample surface are examined. Change in color is shown by a ΔE value tested by an X-rite colorimeter (dark: ΔE≦0.7; light: ΔE≦1). Before performing the UV testing, the testing plate to be tested is first measured for chromatic aberration by the colorimeter, to obtain L1, a1, and b1 values. After UV radiation, the testing plate is again measured for chromatic aberration by the colorimeter, to obtain L2, a2, and b2 values. The ΔE value is calculated according to the following equation:

ΔE=\sqrt{(L2−L1)²+(a2−a1)²+(b2−b1)²}

The sample surface is inspected for the presence of blistering or cracking. Thereafter, one 405 tape is applied over the coated surface (compacted by finger) and is removed by pulling it off rapidly back over itself in an angle of 90° relative to the coat surface. The coated surface is examined for presence of exfoliation when peeling the tape.

3. Cosmetics Testing

10 g of each of the following cosmetics items is put in a measuring glass and mixed homogeneously (one cosmetics is used only once and using every other day is prohibited): Dabao Beauty Day Cream/Nivea man hydrating, Dabao refreshing and moisturizing sunscreen/Vaseline intensive care hand & nail, Dabao SOD protein cream/Johnson baby lotion, Johnson baby oil, Coppertone sport sunscreen SPF30, and oppertone ultraguard sunscreen SPF50. The resulting mixture is coated evenly onto the sample surface with a toothbrush. The sample coated with cosmetics is put in an environment testing furnace, and is tested at a temperature of 70° C. and a humidity of 85% for 48 hr and 72 hr. Further, the sample coated with the above cosmetics is placed at normal temperature for 4 hr.

After testing, changes in color, gloss, and surface roughness of the sample surface are examined. The sample surface is inspected for the presence of blistering or cracking. Thereafter, one 405 tape is applied over the coated surface (compacted by finger) and is removed by pulling it off rapidly back over itself in an angle of 90° relative to the coat surface. The coated surface is examined for presence of exfoliation when peeling the tape.

4. Wet-Wet Cycle Testing

The testing sample is subjected to the following cycle: transiting from 21° C., 60% RH to −40° C. after 3 hr, and keeping at such conditions for 2 hr; then transiting from −40° C. to 85° C., 50% RH after 6 hr, and keeping at such conditions for 2 hr; transiting to 21° C., 60% RH, one cycle ending. 5 cycles is performed in total.

After testing, the sample surface is examined for presence of obvious color difference. The sample surface is inspected for the presence of blistering, cracking, or deformation. Thereafter, one 405 tape is applied over the coated surface (compacted by finger) and is removed by pulling it off rapidly back over itself in an angle of 90° relative to the coat surface. The coated surface is examined for presence of exfoliation when peeling the tape.

5. Hot Water Bath Testing

The sample is examined according to appearance inspection specification before performing the testing, to assess whether the appearance shows adverse defect such as pitting or pinhole. The testing is carried out using distilled water. After the temperature of water reaches 80° C., the sample is put in distilled water and kept for 30 min. The sample cannot be disposed layer-by-layer during testing. The sample remains at room temperature (25° C.) after more than 2 hr finishing the testing.

After testing, the sample surface is visually examined for presence of erosion, cracking, blistering, or erasion. Thereafter, one 405 tape is applied over the coated surface (compacted by finger) and is removed by pulling it off rapidly back over itself in an angle of 90° relative to the coat surface. The coated surface is examined for presence of exfoliation when peeling the tape.

6. Vibratory Wearing Testing

The testing sample (post-baking product) is assembled into a complete device and put into a vibratory wearing tester (R180/530 TE 30, Rosler, German). The testing is performed according to standard testing procedure. After the testing is finished, the film peeling area of the coated surface is measured.

TABLE 3
Testing results for each performance

| | | | | | | Vibratory |
|---|---|---|---|---|---|---|
| | | UV | Cosmetic | Wet-wet | Hot water | wearing |
| | adhesion | radiation | testing | cycle | bath tesing | testing |
| Example | pass, | pass, no | pass, no | pass, no | pass, no | peeling |
| 11 | peeling | change, | change, no | change, no | change, no | area of |
| | area<5% | ΔE = 0.15, | coating | coating | coating | coating at |
| | | no coating | peeling off | peeling off | peeling off | corner |
| | | peeling off | | | | <1 mm² |
| Example | pass, | pass, no | pass, no | pass, no | pass, no | peeling |
| 12 | peeling | change, | change, no | change, no | change, no | area of |
| | area<5% | ΔE = 0.15, | coating | coating | coating | coating at |
| | | no coating | peeling off | peeling off | peeling off | corner |
| | | peeling off | | | | <1 mm² |
| Example | pass, | pass, no | pass, no | pass, no | pass, no | peeling |
| 13 | peeling | change, | change, no | change, no | change, no | area of |
| | area<5% | ΔE = 0.15, | coating | coating | coating | coating at |
| | | no coating | peeling off | peeling off | peeling off | corner |
| | | peeling off | | | | <1 mm² |
| Example | pass, | pass, no | pass, no | pass, no | pass, no | peeling |
| 14 | peeling | change, | change, no | change, no | change, no | area of |
| | area<5% | ΔE = 0.15, | coating | coating | coating | coating at |
| | | no coating | peeling off | peeling off | peeling off | corner |
| | | peeling off | | | | <1 mm² |
| Example | pass, | pass, no | pass, no | pass, no | pass, no | peeling |
| 15 | peeling | change, | change, no | change, no | change, no | area of |
| | area<5% | ΔE = 0.15, | coating | coating | coating | coating at |
| | | no coating | peeling off | peeling off | peeling off | corner |
| | | peeling off | | | | <1 mm² |

Whereas particular embodiments of this invention have been described above for purposes of illustration, it will be evident to those skilled in the art that numerous variations of the details of the present invention may be made without departing from the invention as defined in the appended claims.

What is claimed is:

1. A multi-layer coating system, comprising a first coating composition and a second coating composition, wherein the first coating composition comprises an acrylic resin (a) having a glass transformation temperature (Tg) of at least 70° C. and the second coating composition comprises a three-functionality polyester acrylate, a six-functionality polyurethane acrylate, and a nine-functionality polyurethane acrylate.

2. A multi-layer coating system according to claim 1, wherein the acrylic resin (a) has a Tg in a range of from 75° C. to 90° C.

3. A multi-layer coating system according to claim 1, wherein said first coating composition further comprises an acrylic resin (b) having a glass transformation temperature (Tg) in a range of from 30° C. to 65° C.

4. A multi-layer coating system according to claim 3, wherein said first coating composition comprises 10-50 wt % of an acrylic resin (a) and 5-25 wt % of an acrylic resin (b), based on the weight of the said first coating composition.

5. A multi-layer coating system according to claim 1, wherein said three-functionality polyester acrylate is a reaction product of hydroxyl polyester and acrylic acid.

6. A multi-layer coating system according to claim 1, wherein said six-functionality polyurethane acrylate is a condensation product from pentaerythritol triacrylate, aliphatic diisocyanate, and hydroxyl polyol.

7. A multi-layer coating system according to claim 1, wherein said nine-functionality polyurethane acrylate is a reaction product of polyisocyanate and hydroxyl-acrylate.

8. A multi-layer coating system according to claim 1, wherein said second coating composition comprises 5-25 wt % of a three-functionality polyester acrylate, 5-25 wt % of a six-functionality polyurethane acrylate, and 5-50 wt % of a nine-functionality polyurethane acrylate, based on the weight of the said second coating composition.

9. A method of forming a multi-layer coating system on a substrate, comprising:
(1) applying a first coating composition to at least a portion of the substrate, to form a base coat; and
(2) applying a second coating composition to at least a portion of the base coat, to form a clear coat,
wherein the first coating composition comprises an acrylic resin (a) having a glass transformation temperature (Tg) of at least 70° C. and the second coating composition comprises a three-functionality polyester acrylate, a six-functionality polyurethane acrylate, and a nine-functionality polyurethane acrylate.

10. A coated substrate, comprising:
(i) a substrate, and
(ii) a multi-layer coating system deposited on at least a portion of the substrate, the multi-layer coating system comprising a first coating composition and a second coating composition, wherein the first coating composition comprises an acrylic resin (a) having a glass transformation temperature (Tg) of at least 70° C. and the second coating composition comprises a three-functionality polyester acrylate, a six-functionality polyurethane acrylate, and a nine-functionality polyurethane acrylate.

11. A coated substrate according to claim 10, wherein the substrate comprises a plastic substrate formed from the group consisting of polypropylene, acrylonitrile-butadiene-styrene, glass fiber, and any combination thereof.

12. A coated substrate according to claim 10, wherein the substrate is a substrate useful for a mobile phone, a personal digital assistant, a smart-phone, and a personal computer.
